(19) United States
(12) Patent Application Publication
(10) Pub. No.: US 2022/0253644 A1
(43) Pub. Date: Aug. 11, 2022

(54) PREDICTION DEVICE, PREDICTION METHOD, AND PREDICTION PROGRAM

(71) Applicant: NIPPON TELEGRAPH AND TELEPHONE CORPORATION, Tokyo (JP)

(72) Inventors: Takayuki ADACHI, Tokyo (JP); Akira NAKAYAMA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/618,440

(22) PCT Filed: Jun. 12, 2019
(86) PCT No.: PCT/JP2019/023341

§ 371 Date: Dec. 11, 2021

(51) Int. Cl. G06K 9/62

(52) U.S. Cl. CPC G06K 9/6215; G06K 9/6224; G06K 9/6289

(57) ABSTRACT

It is possible to make a prediction with high accuracy even for a rapid change in the measurement data. A measurement point-to-point information generation unit (130) generates, based on setting data for making a prediction for a plurality of received measurement points, measurement point-to-point information which is information about between the measurement points. A change data generation unit (140) generates change data indicative of a change in the measurement data based on the received measurement data up to the current time. A prediction unit (150) predicts, for each of the plurality of measurement points, based on the measurement point-to-point information, the measurement data, and the change data, measurement data at the measurement point at a time after the current time.

### TECHNICAL FIELD

The present disclosure relates to a prediction device, a prediction method, and a prediction program.

### BACKGROUND ART

In the venues for a large-scale event, many participants may be concentrated around a certain venue, which becomes crowded during the event. Thus, it is important for the people involved in the sponsored event to understand the current situation and take measures before the venue becomes crowded so as to avoid danger due to the crowding. For example, a large number of people may move between the venue and a station all at once when entering or leaving the venue.

In order to avoid such danger, it is conceivable to carry out simulations in advance to consider measures, predict the occurrence of a situation, and take prepared measures as necessary before the occurrence of danger. In addition, the number of people passing through arbitrary points around the venue is measured in advance, and movement information of the event participants that matches the measurement result is obtained for simulation, so that the reproducibility can be improved.

Therefore, there is a technique for sequentially obtaining a future arrival time distribution for the venue from the total number of visitors and sequentially collected visitor arrival times at the venue on the event day for a large-scale event to attract customers (NPL 1). In the technique of NPL 1, the number of people passing through each point around the venue is measured, the arrival time of the visitors is estimated based on the resulting data, and the above-mentioned conventional technique is applied to obtain a future arrival time distribution for the venue so that the number of people passing through each point in the future is given back. This makes it possible to predict the number of people passing through each point.

### CITATION LIST

### Non Patent Literature

[NPL 1] Masahiro Kohjima, Hiroshi Kiyotake, Tatsushi Matsubayashi, Hisako Shiohara, and Hiroyuki Toda, “Uchikiri Deta ni Taisuru Kongou Moderu no Onrain EM Hou no Doushutsu to Daikibo Shuukyaku Ibento ni Okeru Touchaku Jikan Bunpu Suitei (Deriving Online EM Method for Mixture Models with Censored Data and Estimating Arrival Time Distribution for Large Scale Event to Attract Customers)”, The 10th Forum on Data Engineering and Information Management (DEIM Forum 2018), J7-1, 2018.

### SUMMARY OF THE INVENTION

### Technical Problem

However, in the technique of NPL 1, since the measurement results of the respective measurement points are optimized to fit as a whole, there is a problem that the prediction may not be successfully performed for a particularly rapid change in measurement.

The technique disclosed herein has been made in view of the foregoing, and an object of the disclosure is to provide a prediction device, a prediction method, and a prediction program which are capable of making a prediction with high accuracy even for a rapid change in measurement data.

### Means for Solving the Problem

A first aspect of the present disclosure is a prediction device including: a setting data input unit that receives input of setting data for prediction for a plurality of measurement points; a measurement data input unit that receives, for each of the plurality of measurement points, input of measurement data at the measurement point; a measurement point-to-point information generation unit that generates, based on the setting data, measurement point-to-point information that is information about between the measurement points; a change data generation unit that generates, based on the measurement data up to a current time, received by the measurement data input unit, change data indicative of a change in the measurement data; and a prediction unit that predicts, for each of the plurality of measurement points, based on the measurement point-to-point information, the measurement data, and the change data, measurement data at the measurement point at a time after the current time.

A second aspect of the present disclosure is a prediction method including: receiving, by a setting data input unit, input of setting data for prediction for a plurality of measurement points; receiving, by a measurement data input unit, for each of the plurality of measurement points, input of measurement data at the measurement point; generating, by a measurement point-to-point information generation unit, based on the setting data, measurement point-to-point information that is information about between the measurement points; generating, by a change data generation unit, based on the measurement data up to a current time, received by the measurement data input unit, change data indicative of a change in the measurement data; and predicting, by a prediction unit, for each of the plurality of measurement points, based on the measurement point-to-point information, the measurement data, and the change data, measurement data at the measurement point at a time after the current time.

A third aspect of the present disclosure is a prediction program for causing a computer to execute: receiving, by a setting data input unit, input of setting data for prediction for a plurality of measurement points; receiving, by a measurement data input unit, for each of the plurality of measurement points, input of measurement data at the measurement point; generating, by a measurement point-to-point information generation unit, based on the setting data, measurement point-to-point information that is information about between the measurement points; generating, by a change data generation unit, based on the measurement data up to a current time, received by the measurement data input unit, change data indicative of a change in the measurement data; and predicting, by a prediction unit, for each of the plurality of measurement points, based on the measurement point-to-point information, the measurement data, and the change data, measurement data at the measurement point at a time after the current time.

### Effects of the Invention

According to the technique disclosed herein, it is possible to make a prediction with high accuracy even for a rapid change in the measurement data.

### BRIEF DESCRIPTION OF DRAWINGS

FIG. 1 is a block diagram illustrating a schematic configuration of a computer that functions as a prediction device according to an embodiment.

FIG. 2 is a block diagram illustrating an example of a functional configuration of the prediction device according to the embodiment.

FIG. 3 is a diagram illustrating a relationship between an upstream measurement point and a downstream measurement point.

FIG. 4 illustrates an example of prediction.

FIG. 5 is a flowchart illustrating a prediction processing routine of the prediction device according to the present embodiment.

### DESCRIPTION OF EMBODIMENTS

### Configuration of Prediction Device According to Embodiment of Present Disclosed Technique

Embodiment examples of the disclosed technique will be described below with reference to the drawings. Note that the same reference numerals are given to the same or equivalent components and parts throughout the drawings. Further, the dimensional ratios in the drawings are exaggerated for convenience of explanation and may differ from the actual ratios.

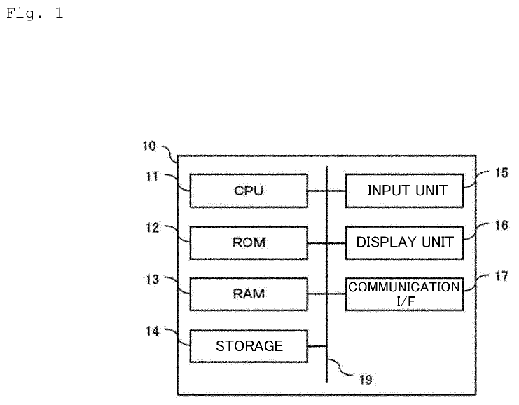

FIG. 1 is a block diagram illustrating a hardware configuration of a prediction device 10 according to the present embodiment. As illustrated in FIG. 1, the prediction device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The respective components are communicably connected to each other via a bus 19.

The CPU 11, which is a central arithmetic processing unit, executes various types of programs and controls each component. Specifically, the CPU 11 reads a program from the ROM 12 or the storage 14, and executes the program using the RAM 13 as a work area. The CPU 11 controls each of the above-mentioned components and performs various types of arithmetic processing in accordance with the program stored in the ROM 12 or the storage 14. In the present embodiment, the ROM 12 or the storage 14 stores a prediction program for executing prediction processing.

The ROM 12 stores various types of programs and various types of data. The RAM 13 serves as a work area to temporarily store programs or data. The storage 14 is composed of an HDD (Hard Disk Drive) or SSD (Solid State Drive) to store various types of programs including an operating system, and various types of data.

The input unit 15 includes a pointing device such as a mouse and a keyboard, and is used for performing various types of inputs.

The display unit 16 is, for example, a liquid crystal display and displays various types of information. The display unit 16 may adopt a touch panel type to function as the input unit 15.

The communication interface 17 is an interface for communicating with other devices, and uses, for example, standards such as Ethernet (registered trademark), FDDI, and Wi-Fi (registered trademark).

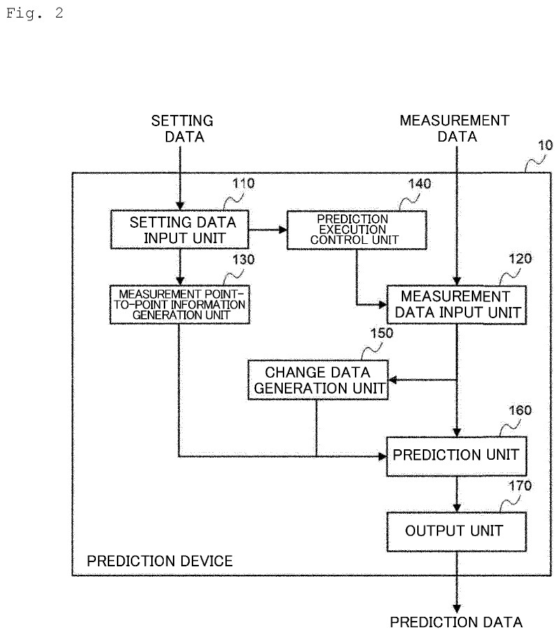

Next, a functional configuration of the prediction device 10 will be described. FIG. 2 is a block diagram illustrating an example of the functional configuration of the prediction device 10.

As illustrated in FIG. 2, the prediction device 10 includes a setting data input unit 110, a measurement data input unit 120, a measurement point-to-point information generation unit 130, a prediction execution control unit 140, a change data generation unit 150, a prediction unit 160, and an output unit 170, which serve as functional components. Each functional component is realized by the CPU 11 reading the prediction program stored in the ROM 12 or the storage 14, loading the prediction program into the RAM 13, and executing the prediction program.

The setting data input unit 110 receives input of setting data for making a prediction for a plurality of measurement points. The setting data includes a directed graph in which each of a plurality of points is defined as a node and each path between the points is defined as an edge. For example, when a target to be simulated is a flow of people in a large-scale event including a road network composed of a plurality of roads, the directed graph is expressed with an end point of each road as a node and with each road as an edge. In the directed graph, the direction of the road is also taken into consideration. Hereinafter, a case where the directed graph represents a road network will be described as an example.

Further, the setting data includes information on the measurement points. The information on the measurement points is, for example, of the nodes, a list of nodes that are the measurement points. Herein, each measurement point is always described as being in a node. Further, the information on the measurement points includes information on what kind of measurement data are to be measured at the measurement point. In the following, a case will be described by way of example in which the measurement data to be measured at the measurement point is the number of people passing through the measurement point. Even for the same edge, if both the immediately preceding node and the immediately following node are specified, the number of passing people in a different direction is represented.

Further, the setting data includes information on movement speed information. For example, as the movement speed information, the average value of the movement speed and the normal distribution can be assumed, and the mean and standard deviation can be adopted. Further, a coefficient for changing the movement speed may be given for each road.

Further, the setting data includes the start and end dates and times of execution of prediction processing by the prediction device 10. Then, the setting data input unit 110 passes the received setting data to the measurement point-to-point information generation unit 130 and the prediction execution control unit 140.

The measurement data input unit 120 receives, for each of the plurality of measurement points, input of measurement data at the measurement point. Specifically, the measurement data input unit 120 receives, for each of the plurality of measurement points, input of measurement data, which is the number of people passing through the measurement point, at predetermined time intervals. Then, the measurement data input unit 120 passes the received measurement data to the change data generation unit 150 and the prediction unit 160.

The measurement point-to-point information generation unit 130 generates, based on the setting data, measurement point-to-point information that is information about between the measurement points. Specifically, the measurement point-to-point information generation unit 130 obtains, for each of the pairs of the measurement points, based on a directed graph included in the setting data, an upstream-downstream relationship indicative of which of upstream or downstream each measurement point in the pair is, a distance between the paired points, and a moving time between the paired points.

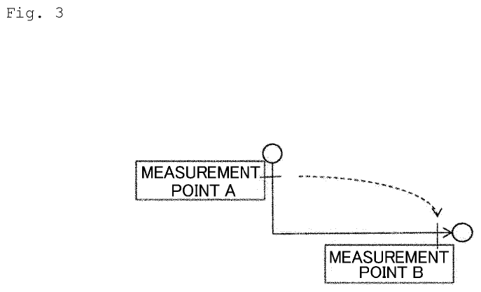

The measurement point-to-point information generation unit 130 obtains, for each of the plurality of measurement points, a measurement point adjacent to that measurement point from the directed graph and the information on the measurement point which are included in the setting data, and sets, as an upstream measurement point, the measurement point heading toward that measurement point which is also the obtained measurement point adjacent to that measurement point. Next, the measurement point-to-point information generation unit 130 sets, as a downstream measurement point, the measurement point associated with the upstream measurement point, and generates a pair of the upstream measurement point and the downstream measurement point. FIG. 3 is a diagram illustrating a relationship between the upstream measurement point and the downstream measurement point. In FIG. 3, the upper circle is a start point, the right circle is a goal point, and A and B are measurement points. In the case of FIG. 3, the upstream-downstream relationship between the measurement point A and the measurement point B is such that the measurement point A is upstream and the measurement point B is downstream. In this way, the measurement point-to-point information generation unit 130 obtains a pair of measurement points having an upstream-downstream relationship from the plurality of measurement points. Further, there is another possible method for generating a pair of upstream and downstream points. For example, the shortest path can be on any measurement point further upstream of the upstream point adjacent to the original point. Alternatively, a pair of measurement points of the upstream point and the downstream point defined in advance in the set data may be used.

Further, the measurement point-to-point information generation unit 130 calculates, based on the distance between the upstream measurement point and the downstream measurement point and the movement speed information included in the setting data, a moving time from the upstream measurement point to the downstream measurement point. Here, when the distance between the measurement points is of the shortest path, that distance is the total of the lengths between nodes, which are passage nodes recorded in advance. Note that instead of the shortest path, a path whose ease of passage (e.g., a relationship between the width and length of a road) is given priority may be used as a path between the measurement points. Further, a path of adjacent measurement points is added to the setting data, and that path may be used as a path between the measurement points. Then, the measurement point-to-point information generation unit 130 passes, for each of the generated pairs of upstream measurement point and downstream measurement point, the measurement point-to-point information including the upstream-downstream relationship, distance, and moving time between the paired points to the prediction unit 160 and the output unit 170.

The prediction execution control unit 140 controls the execution of prediction processing by the prediction device 10. Specifically, the prediction execution control unit 140 causes the measurement data input unit 120 to start receiving input of the measurement data when the date and time to start the execution of the prediction processing included in the setting data comes. Further, the prediction execution control unit 140 causes the measurement data input unit 120 to end receiving the input of the measurement data when the date and time to end the prediction processing included in the setting data comes, and then the processing of the prediction device 10 ends.

The change data generation unit 150 generates change data indicative of a change in the measurement data based on the measurement data up to the current time received by the measurement data input unit 120. Specifically, the change data generation unit 150 generates, for each of the plurality of measurement points, as change data, a change value indicative of a value by which the measurement data at the measurement point up to the current time received by the measurement data input unit 120 changes between the times. As the change value, for example, an increase/decrease value of the measurement data between the times or a change amount represented by the slope of a tangent line at each time in a function representing the measurement data between the times can be used. Further, the change value may be a difference between the maximum value and the minimum value in a predetermined time zone. Then, the change data generation unit 150 passes the generated change data to the prediction unit 160.

The prediction unit 160 predicts, for the downstream measurement point of each of the pairs of measurement points, based on the measurement point-to-point information, the measurement data, and the change data, measurement data at the measurement point at a time after the current time. Specifically, for each of the pairs of measurement points with an upstream-downstream relationship, if the change data at the upstream measurement point A is equal to or larger than a first threshold value determined in advance and the distance between the paired points is within a second threshold value, the prediction unit 160 predicts measurement data at the downstream measurement point B after a predetermined time in a time zone in which the change data is equal to or larger than the first threshold value. As the predetermined time, a moving time from the upstream measurement point A to the downstream measurement point B can be adopted. Further, as the predetermined time, a moving time may be adopted in consideration of the influence of other measurement points. For example, in a case where paths from a plurality of upstream measurement points are joined at a downstream point, a temporary measurement point is set at that junction, the sum of values shifted by the moving times from the upstream points to the junction is set as measurement data at the junction, and the junction is defined as a new upstream point, so that the moving time from the new upstream point to the downstream point can be obtained. Regarding the upstream measurement data, if the path from the upstream measurement point branches and heads for the downstream point, the branching ratio is given as the setting data in advance or calculated from the already acquired measurement data, so that a value obtained by multiplication using the branching ratio for the downstream point can be used as the measurement data from the upstream measurement point. On the other hand, if the change data at the upstream measurement point A is lower than the first threshold value or the distance between the paired points exceeds the predetermined second threshold value, another prediction technique is used. For example, from the measurement data at the downstream measurement point B up to the current time, measurement data at the measurement point B at a time after the current time can be linearly predicted. Note that the present invention is not limited thereto, still another prediction technique may be used.

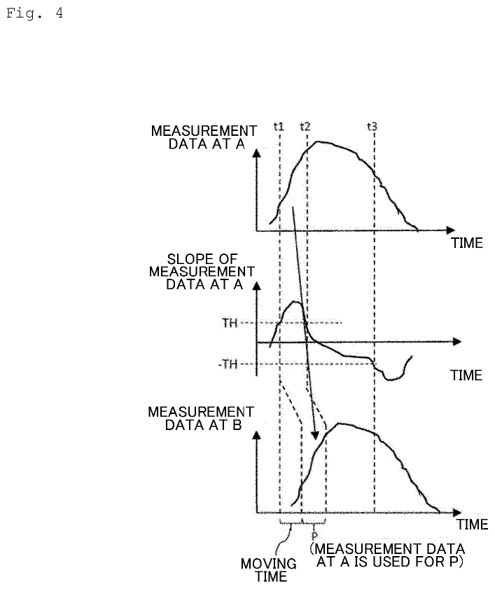

FIG. 4 is a diagram illustrating an example of a case where the prediction unit 160 predicts measurement data at the measurement point B. In this example, the change data will be described as being a slope. Further, in FIG. 4, t2 is set as the current time. A graph at the top in FIG. 4 is a graph representing the measurement data at the measurement point A in time series, with the vertical axis representing the number of passing people and the horizontal axis representing the time. A graph at the middle in FIG. 4 is a graph representing the slope of a tangent line at each time in a function representing the measurement data at the measurement point illustrated in the top in FIG. 4 in time series. In this graph, the vertical axis represents the slope at the measurement data at point A, and the horizontal axis represents the time. Further, a graph at the bottom in FIG. 4 is a graph representing the measurement data at the point B in time series, with the vertical axis representing the number of passing people and the horizontal axis representing the time. If the measurement data up to the current time t2 in FIG. 4 is obtained, the absolute value of the slope in a time zone of (t1 to t2) immediately before the current time t2 in the graph at the middle in FIG. 4 is larger than a first threshold value TH. In this case, since the absolute value of the slope for the measurement point A is larger than the predetermined first threshold value TH, the prediction unit 160 predicts, based on the measurement data at the measurement point A, measurement data at the measurement point B in a time zone (time zone P at the bottom in FIG. 4) after a moving time from the measurement point A to the measurement point B in the time zone (t1 to t2). For example, information on a ratio of the number of people passing through the downstream measurement point to the number of people passing through the upstream measurement point, which is aggregated from the past measurement data, can be held so that measurement data at the downstream measurement point can be predicted by multiplying the measurement data at the upstream measurement point at the corresponding time by the ratio. On the other hand, a time zone in which the absolute value of the slope for the measurement point A is equal to or less than the first threshold value TH (e.g., a time zone of t2 to t3) is predicted by using another method. For example, it is conceivable to make a prediction based on the measurement data at the measurement point B before a time zone after a moving time in the above time zone.

In this way, if there is a time zone with a large amount of change for the upstream measurement point A, it is determined that the downstream measurement point B after the moving time elapses from that time zone is also influenced, and accordingly measurement data at the measurement point B is predicted using the measurement data at the measurement point A. Further, if the distance between the paired measurement points is equal to or less than a second threshold value, it is considered that the upstream measurement point A has a large influence on the downstream measurement point B, and thus this is also taken into consideration to predict measurement data at the downstream measurement point B. If the distance between the measurement point A and the measurement point B is larger than the second threshold value, it is considered that the upstream measurement point A has little influence on the downstream measurement point B, and thus the prediction unit 160 predicts measurement data at the measurement point B by using another method. Then, the prediction unit 160 passes the predicted measurement data for each of the downstream measurement points to the output unit 170.

The output unit 170 outputs the predicted measurement data for each of the downstream measurement points.

### Operation of Prediction Device According to Embodiment of Present Disclosed Technique

Next, the operation of the prediction device 10 will be described.

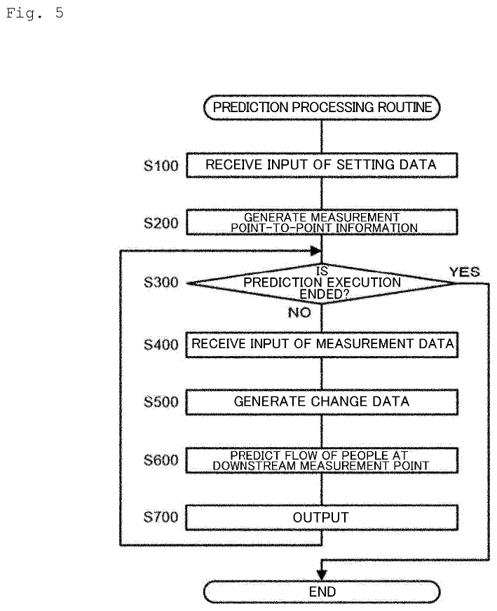

FIG. 5 is a flowchart illustrating a flow of a prediction processing routine performed by the prediction device 10. The prediction processing routine is performed by the CPU 11 reading the prediction program from the ROM 12 or the storage 14, loading the prediction program into the RAM 13, and executing the prediction program. Note that this processing will be described as assuming that the date and time to start the execution of the prediction processing included in the setting data. has now come.

In step S100, the CPU 11 serves as the setting data input unit 110 to receive input of the setting data for making a prediction for a plurality of measurement points.

In step S200, the CPU 11 serves as the measurement point-to-point information generation unit 130 to generate, based on the setting data, the measurement point-to-point information that is information about between the measurement points.

In step S300, the CPU 11 serves as the prediction execution control unit 140 to determine whether or not it is the date and time to end the execution of the prediction processing included in the setting data.

If it is the date and time to end (YES in step S300), in step S400, the CPU 11 serves as the measurement data input unit 120 to receive input of the measurement data at each of the plurality of measurement points.

In step S500, the CPU 11 serves as the change data generation unit 150 to generate change data indicative of a change in the measurement data based on the measurement data up to the current time received in step S110.

In step S600, the CPU 11 serves as the prediction unit 160 to predict, for the downstream measurement point of each of the pairs of measurement points, based on the measurement point-to-point information, the measurement data, and the change data, measurement data at the measurement point at a time after the current time.

In step S700, the CPU 11 serves as the output unit 170 to output the predicted measurement data for each of the downstream measurement points, and returns to step S300.

On the other hand, if it is the date and time to end (YES in step S300), the CPU 11 ends the processing.

As described above, the prediction device according to the embodiment of the present disclosure generates measurement point-to-point information, which is information about between measurement points, based on setting data for making a prediction at a plurality of received measurement points. The prediction device according to the embodiment of the present disclosure generates change data indicative of a change in the measurement data based on the received measurement data up to the current time. The prediction device according to the embodiment of the present disclosure can predict, for each of the plurality of measurement points, based on the measurement point-to-point information, the measurement data, and the change data, measurement data at the measurement point at a time after the current time, so that it is possible to make a prediction with high accuracy even for a rapid change in the measurement data.

Note that the present disclosure is not limited to the above-described embodiment, and various modifications and applications are possible without departing from the scope and spirit of the present invention.

In the above-described embodiment, the example for the movement of people has been described, but the present invention is not limited to this. For example, it can be applied for the movement of animals, the movement of objects, transfer objects in information communication, and the like. In this case, as the measurement data, the number of passing animals, the number of passing objects, and the amount of information of the transferred object can be used.

Further, in the above-described embodiment, the prediction device 10 is configured as one device, but the respective steps of processing may be deployed to separate devices and the prediction processing may be performed via a network.

Note that in the above embodiment, various types of processors other than the CPU may execute the prediction program executed by the CPU reading the software (program). Examples of the processors in this case include PLD (Programmable Logic Device) whose circuitry is reconfigurable after manufacturing, such as FPGA (Field-Programmable Gate Array), a dedicated electric circuit, which is a processor having circuitry specially designed for performing specific processing, such as ASIC (Application Specific Integrated Circuit), and the like. Further, the prediction program may be executed by one of these various types of processors, or a combination of two or more processors of the same type or different types (e.g., a plurality of FPGAs and a combination of a CPU and an FPGA, etc.). Further, the hardware configuration of these various types of processors is, more specifically, an electric circuit in which circuit elements such as semiconductor elements are combined.

Further, in the above embodiment, an aspect has been described in which the prediction program is previously stored (installed) in the ROM 12 or the storage 14. However, the present invention is not limited to this. The program may be provided in the form of being stored in a non-transitory storage medium such as CD-ROM (Compact Disk Read Only Memory), DVD-ROM (Digital Versatile Disk Read Only Memory), and USB (Universal Serial Bus). Further, the program may be in the form of being downloaded from an external device via a network.

The following Notes will be further disclosed with respect to the above embodiment.

### (Note 1)

A prediction device including

a memory; and

at least one processor connected to the memory, wherein

the processor is configured to:

receive input of setting data for prediction for a plurality of measurement points;

receive, for each of the plurality of measurement points, input of measurement data at the measurement point;

generate, based on the setting data, measurement point-to-point information that is information about between the measurement points;

generate, based on the measurement data up to a current time, received by the measurement data input unit, change data indicative of a change in the measurement data; and

predict, for each of the plurality of measurement points, based on the measurement point-to-point information, the measurement data, and the change data, measurement data at the measurement point at a time after the current time.

### (Note 2)

A non-transitory storage medium storing a prediction program that causes a computer to execute:

receiving input of setting data for prediction for a plurality of measurement points;

receiving, for each of the plurality of measurement points, input of measurement data at the measurement point;

generating, based on the setting data, measurement point-to-point information that is information about between the measurement points;

generating, based on the measurement data up to a current time, received by the measurement data input unit, change data indicative of a change in the measurement data; and

predicting, for each of the plurality of measurement points, based on the measurement point-to-point information, the measurement data, and the change data, measurement data at the measurement point at a time after the current time.

### REFERENCE SIGNS LIST

10 Prediction device
11 CPU
12 ROM
13 RAM
14 Storage
15 Input unit
16 Display unit
17 Communication interface
19 Bus
110 Setting data input unit
120 Measurement data input unit
130 Measurement point-to-point information generation unit
140 Prediction execution control unit
150 Change data generation unit
160 Prediction unit
170 Output unit

1. A prediction device comprising circuitry configured to execute a method comprising:
receiving input of setting data for prediction for a plurality of measurement points;
receiving, for each of the plurality of measurement points, input of measurement data at a measurement point;
generating, based on the setting data, measurement point-to-point information that is information about aspects of between the plurality of measurement points;
generating, based on the measurement data up to a current time, change data indicative of a change in the measurement data; and
predicting, for each of the plurality of measurement points, based on the measurement point-to-point information, the measurement data, and the change data, measurement data at the measurement point at a time after the current time.

2. The prediction device according to claim 1, wherein
the setting data includes a directed graph in which each of the plurality of points is defined as a node and each path between the points is defined as an edge, the circuitry configured to execute the method further comprising:
generating, for each of pairs of the plurality of measurement points, based on the edge included in the setting data, measurement point-to-point information including an upstream-downstream relationship indicative of which of upstream or downstream each measurement point in the pair is, a distance between the paired points, and a moving time of a measurement target between the paired measurement points; and
predicting, for each of the downstream measurement points of each of the pairs, based on the measurement data at the upstream measurement point of each of the pairs, measurement data at the downstream measurement point after the moving time for the pair from the current time when the change data at the upstream measurement point satisfies a predetermined condition.

3. The prediction device according to claim 2, the circuitry configured to execute the method further comprising:
generating, as the change data, a change value indicative of a degree of change of the measurement data at each time up to the time of a prediction time point, and
predicting measurement data at the downstream measurement point in a time zone after the moving time in a time zone in which the magnitude of an absolute value of the change value at the upstream measurement point is equal to or larger than a predetermined first threshold.

4. The prediction device according to claim 3, the circuitry configured to execute the method further comprising:
predicting, when the change data is equal to or larger than the first threshold value and the distance between the paired points is within a second threshold value, measurement data at the measurement point after the moving time in the time zone in which the change data is equal to or larger than the first threshold value.

5. A prediction method comprising:
receiving input of setting data for prediction for a plurality of measurement points;
receiving, for each of the plurality of measurement points, input of measurement data at a measurement point;
generating, based on the setting data, measurement point-to-point information that is information about between the plurality of measurement points;
generating, based on the measurement data up to a current time, change data indicative of a change in the measurement data; and
predicting, for each of the plurality of measurement points, based on the measurement point-to-point information, the measurement data, and the change data, measurement data at the measurement point at a time after the current time.

6. A computer-readable non-transitory recording medium storing computer-executable program instructions that when executed by a processor cause a computer system to execute a method comprising:
receiving, input of setting data for prediction for a plurality of measurement points;
receiving, for each of the plurality of measurement points, input of measurement data at a measurement point;
generating, based on the setting data, measurement point-to-point information that is information about between the plurality of measurement points;
generating, based on the measurement data up to a current time, change data indicative of a change in the measurement data; and
predicting, for each of the plurality of measurement points, based on the measurement point-to-point information, the measurement data, and the change data, measurement data at the measurement point at a time after the current time.

7. The prediction device according to claim 1, wherein the setting data include movement speed information.

8. The prediction device according to claim 1, wherein the setting data include start and end dates and times of executing prediction processing.

9. The prediction device according to claim 1, wherein the measurement data include a number of people passing through a measurement point.

10. The prediction method according to claim 5, wherein the setting data includes a directed graph in which each of the plurality of points is defined as a node and each path between the points is defined as an edge, the method further comprising:
generating, for each of pairs of the plurality of measurement points, based on the edge included in the setting data, measurement point-to-point information including an upstream-downstream relationship indicative of which of upstream or downstream each measurement point in the pair is, a distance between the paired points, and a moving time of a measurement target between the paired measurement points; and
predicting, for each of the downstream measurement points of each of the pairs, based on the measurement data at the upstream measurement point of each of the pairs, measurement data at the downstream measurement point after the moving time for the pair from the current time when the change data at the upstream measurement point satisfies a predetermined condition.

11. The prediction method according to claim 5, wherein the setting data include movement speed information.

12. The prediction method according to claim 5, wherein the setting data include start and end dates and times of executing prediction processing.

13. The prediction method according to claim 5, wherein the measurement data include a number of people passing through a measurement point.

14. The computer-readable non-transitory recording medium according to claim 6, wherein the setting data includes a directed graph in which each of the plurality of points is defined as a node and each path between the points is defined as an edge, the computer-executable program instructions that when executed by a processor cause a computer system to execute the method further comprising:
generating, for each of pairs of the plurality of measurement points, based on the edge included in the setting data, measurement point-to-point information including an upstream-downstream relationship indicative of which of upstream or downstream each measurement point in the pair is, a distance between the paired points, and a moving time of a measurement target between the paired measurement points; and
predicting, for each of the downstream measurement points of each of the pairs, based on the measurement data at the upstream measurement point of each of the pairs, measurement data at the downstream measurement point after the moving time for the pair from the current time when the change data at the upstream measurement point satisfies a predetermined condition.

15. The computer-readable non-transitory recording medium according to claim 6, wherein the setting data include movement speed information.

16. The computer-readable non-transitory recording medium according to claim 6, wherein the measurement data include a number of people passing through a measurement point.

17. The prediction method according to claim 10, the method further comprising:
generating, as the change data, a change value indicative of a degree of change of the measurement data at each time up to the time of a prediction time point, and
predicting measurement data at the downstream measurement point in a time zone after the moving time in a time zone in which the magnitude of an absolute value of the change value at the upstream measurement point is equal to or larger than a predetermined first threshold.

18. The computer-readable non-transitory recording medium according to claim 14, the computer-executable program instructions that when executed by a processor cause a computer system to execute the method further comprising:
generating, as the change data, a change value indicative of a degree of change of the measurement data at each time up to the time of a prediction time point, and
predicting measurement data at the downstream measurement point in a time zone after the moving time in a time zone in which the magnitude of an absolute value of the change value at the upstream measurement point is equal to or larger than a predetermined first threshold.

19. The prediction method according to claim 17, the method further comprising:
predicting, when the change data is equal to or larger than the first threshold value and the distance between the paired points is within a second threshold value, measurement data at the measurement point after the moving time in the time zone in which the change data is equal to or larger than the first threshold value.

20. The computer-readable non-transitory recording medium according to claim 18, the computer-executable program instructions that when executed by a processor cause a computer system to execute the method further comprising:
predicting, when the change data is equal to or larger than the first threshold value and the distance between the paired points is within a second threshold value, measurement data at the measurement point after the moving time in the time zone in which the change data is equal to or larger than the first threshold value.
